(19) United States
(12) Patent Application Publication
(10) Pub. No.: US 2013/0235107 A1
(43) Pub. Date: Sep. 12, 2013

(54) COLOR MEASURING METHOD AND RECORDING APPARATUS

(71) Applicant: CANON KABUSHIKI KAISHA, Tokyo (JP)

(72) Inventors: Tsuyoshi Ibe, Yokohama-shi (JP); Masaya Uetsuki, Yokohama-shi (JP); Toshimitsu Danzuka, Tokyo (JP); Taku Yokozawa, Yokohama-shi (JP); Masataka Kato, Yokohama-shi (JP); Asako Tomida, Kawasaki-shi (JP); Hiroaki Komatsu, Yokohama-shi (JP); Shin Genta, Yokohama-shi (JP)

(73) Assignee: CANON KABUSHIKI KAISHA, Tokyo (JP)

(21) Appl. No.: 13/785,688

(22) Filed: Mar. 5, 2013

(30) Foreign Application Priority Data
Mar. 9, 2012 (JP) 2012-052893

(51) Int. Cl. B41J 2/045

(52) U.S. Cl. CPC B41J 2/0458
USPC 347/14

(57) ABSTRACT

A color measuring method includes: recording color patterns on a sheet by an inkjet head; measuring colors of the color patterns formed on the sheet; and recovering the inkjet head, wherein the recovering is prohibited within a period after the recording and before the measuring.

### BACKGROUND OF THE INVENTION

1. Field of the Invention

The present invention relates to a recording apparatus provided with a color measuring device for measuring a color measuring pattern recorded on a sheet by ejecting ink on the sheet from an inkjet head, and a color correcting method and a recording method for the recording apparatus.

2. Description of the Related Art

There is generally known an inkjet recording apparatus in which, for obtaining a desired color reproduction, the color image having been recorded is measured, a color calibration is performed based upon the measured data, and the result is reflected in the subsequent image record data. At this time, it is general to perform the process comprising a step for recording on a sheet color patterns in each of which color patches each having ink of each color are arrayed in a lattice shape, a step for drying the color pattern, and next a step for moving a color measuring sensor in a width direction of the sheet to measure the color patterns one row by one row.

Japanese Patent Laid-Open No. 2008-254221, as the structure for shortening the time from recording completion to color measuring start, discloses a recording apparatus provided with a color measuring device in which a recording component, a color measuring component, and a drying component are arranged in that order in the conveying direction of a sheet, and proposes a sequence of recording, drying, and color measuring operations based upon this apparatus.

### SUMMARY OF THE INVENTION

A color of an image on a sheet on which ink has been applied can change depending on the drying degree of the ink until the drying degree of the ink is increased to some extent to become stable. For obtaining the desired color reproduction by performing a color calibration with high accuracy, it is desired to appropriately set the time from recording completion to color measuring start to make the drying degree of the ink at color measuring constant.

Incidentally it is known that in the inkjet recording apparatus, for preventing or improving an ejection defect caused by the clogging or the like of ink ejection openings provided in an inkjet head or ink stains on a surface of the inkjet head, a recovering operation of the inkjet head is performed. It is possible to successively perform more stable image formation by performing the recovering operation. Japanese Patent Laid-Open No. 2008-254221 discloses the sequence of the recording, drying, and color measuring operations, but has no description referring to the recovering operation of the inkjet head with the aim at maintaining the stable ejection performance of the inkjet head.

Therefore, an object of the present invention is to appropriately set the time from recording completion to color measuring start of color patterns in consideration of performing the recovering operation for more stable color pattern formation.

For achieving the above object, a color measuring method according to the present invention comprises: recording color patterns on a sheet by an inkjet head; measuring colors of the color patterns formed on the sheet; and recovering the inkjet head, wherein the recovering is prohibited within a period after the recording and before the measuring.

A recording apparatus according to the present invention comprises: a recording unit having an inkjet head configured to record patterns on a sheet; a reading unit configured to read the patterns formed by the recording unit; and a recovering unit configured to recover the inkjet head, wherein the recovering by the recovering unit is prohibited within a period after the recording by the recording unit and before the reading by the reading unit.

Further features of the present invention will become apparent from the following description of exemplary embodiments (with reference to the attached drawings).

### BRIEF DESCRIPTION OF THE DRAWINGS

FIG. 1A is an entire schematic diagram showing a recording apparatus according to a first embodiment;

FIG. 1B is a section schematic diagram explaining apart of an internal configuration of the recording apparatus;

FIG. 1C is a schematic perspective view showing a recovering unit of the recording apparatus;

FIG. 2 is a cross section showing an example of an internal configuration of the recording apparatus according to the first embodiment;

FIG. 3A is a diagram explaining a series of recording, drying, color measuring, and sheet discharging operations by the configuration in FIG. 2;

FIG. 3B is a diagram explaining a series of recording, drying, color measuring, and sheet discharging operations by the configuration in FIG. 2;

FIG. 3C is a diagram explaining a series of recording, drying, color measuring, and sheet discharging operations by the configuration in FIG. 2;

FIG. 4 is a block diagram showing a configuration example of a control system in the recording apparatus according to the first embodiment;

FIG. 5A is a flow chart showing a color measuring sequence according to the first embodiment;

FIG. 5B is timing charts of the first embodiment and a comparative example;

FIG. 6 is a flow chart showing a color measuring sequence according to a second embodiment;

FIG. 7 is a flow chart showing a color measuring sequence according to a third embodiment;

FIG. 8A is color patterns for color measuring configured of a plurality of pattern rows according to a fourth embodiment; and

FIG. 8B is a timing chart of a color measuring sequence on color patterns for color measuring recorded by a plurality of times of recording operations.

### DESCRIPTION OF THE EMBODIMENTS

Hereinafter, preferred embodiments according to the present invention will be in detail explained with reference to the accompanying drawings.

### First Embodiment

### <Recording Apparatus>

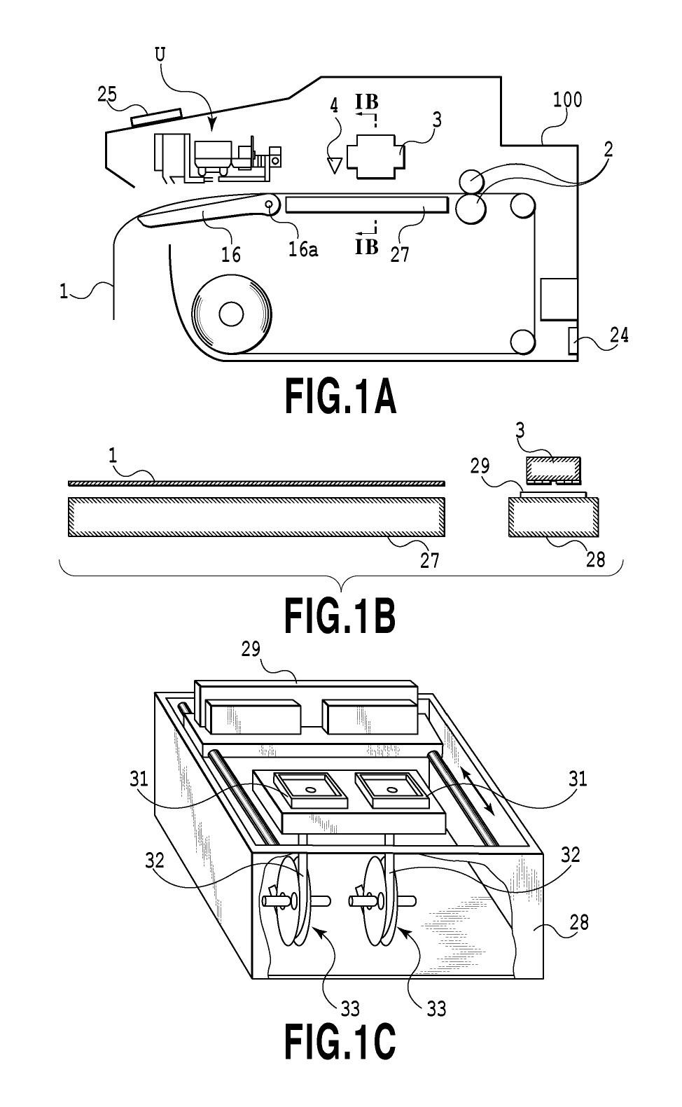

FIG. 1A is a schematic diagram showing a recording apparatus according to an embodiment in the present embodiment. The recording apparatus 100 is a serial scan type printer of an inkjet method in which an inkjet head 3 scans in a main scan direction crossing a conveying direction (sub scan direction) of a sheet 1, and ink is ejected on the sheet 1 from the inkjet head 3 to form an image thereon.

The sheet 1 is set in the recording apparatus 100 in the form of a paper roll. As a command of a recording start is input to the recording apparatus 100 from an operation panel 25, the sheet 1 is conveyed in a sheet conveying direction (sub scan direction) by tight sandwich and rotation by pair conveying rollers 2. As the sheet 1 is conveyed to a recording region of the inkjet head 3, the sheet 1 is held by a platen 27, while ink ejected from the inkjet head 3 according to record data is applied on a surface of the sheet 1 to record color patterns for color measuring. The sheet 1, on which the color patterns for color measuring are recorded, is next conveyed to a drying region by a color measuring unit U mounted to the recording apparatus 100, and is dried therein. After that, the sheet 1 is conveyed to a color measuring region by the color measuring unit U to be subjected to the color measuring. After completion of the color measuring, the sheet 1 is cut by a cutter 4 to be separated from the paper roll, and is discharged from the recording apparatus 100 under its own weight with rotation of a discharge guide 16.

### <Recovering Unit>

Next, an explanation will be made of a configuration example and a recovering operation of the recovering unit of the recording apparatus according to the first embodiment in the present invention. FIG. 1B is a section schematic diagram showing a partial internal mechanism of the recording apparatus, taken bylines IB-IB shown in FIG. 1A. The inkjet head 3 stops in a home position or a back position as needed before starting a recording operation or during the recording operation. In the present specification, the home position means one of both side positions of the platen 27 in which the inkjet head 3 is out of the platen 27 in the main scan direction at the time of moving the inkjet head 3 in the main scan direction. Likewise the back position means the other position at the opposite to the home position in such a manner as to put the platen 27 between the home position and the back position in the main scan direction. FIG. 1B shows a state where the inkjet head 3 is in a home position. A recovering unit 28 including caps and a wiper is arranged as a recovering unit for normalizing ejection of the inkjet head 3 in the vicinity of the home position.

FIG. 1C is a schematic perspective view showing a configuration example of the recovering unit 28 shown in FIG. 1B. Caps 31 are supported by an elevating mechanism (not shown) to be capable of elevating. At an up position thereof, capping is performed for each face of, for example, three ejection portions in the inkjet head 3 to perform protection or suction recovery of the ejection portion at a non-recording operation or the like. At a recording operation, the cap 3 is set to a down position of avoiding interference with the inkjet head 3, and opposes the face to receive preliminary ejection. In addition, for wiping out the ink having adhered to the face, wiping for rubbing the face by a rubber wiper 29 is performed.

Suction pumps 33, in a state where the cap 31 is jointed to the face of the inkjet head 3 to form a sealed space therebetween, respectively produce a vacuum inside the seal space. Therefore ink can be filled in the inkjet head 3 and in the ejection portion from an ink tank (not shown), and dusts, adherents, air bubbles and the like present in an ejection opening or an ink passage inward thereof can be suctioned for removal. In an illustrated example, the suction pump 33 in the form of a tube pump is used. The suction pump 33 comprises a member having a curved surface for holding a flexible tube 32 (at least apart thereof) to be along the curved surface, rollers capable of pressing the flexible tube 32 toward the member, and a ratable roller support portion supporting the rollers. That is, the rollers squeeze the flexible tube on the curved surface forming member while rotating, with rotation of the roller support portion in a predetermined direction. Following it, a vacuum is produced in the sealed space formed by the cap 31 to suction the ink from the ejection opening, and the ink is suctioned into the tube or the suction pump from the cap 31. On the other hand, the suctioned ink is further carried toward an appropriate member (for example, a waste ink absorber (not shown)).

In addition, the suction pump 33 can be operated not only for performing the aforementioned suction recovery but also for discharging the ink received in the cap 31 by a preliminary ejection operation performed in a state where the cap 31 opposes the face. That is, when the preliminarily ejected ink retained in the cap 31 reaches to a predetermined amount, the suction pump 33 is operated. Thereby the ink retained in the cap 31 can be carried through the tube 32 to the waste ink absorbent.

### <Color Measuring Unit>

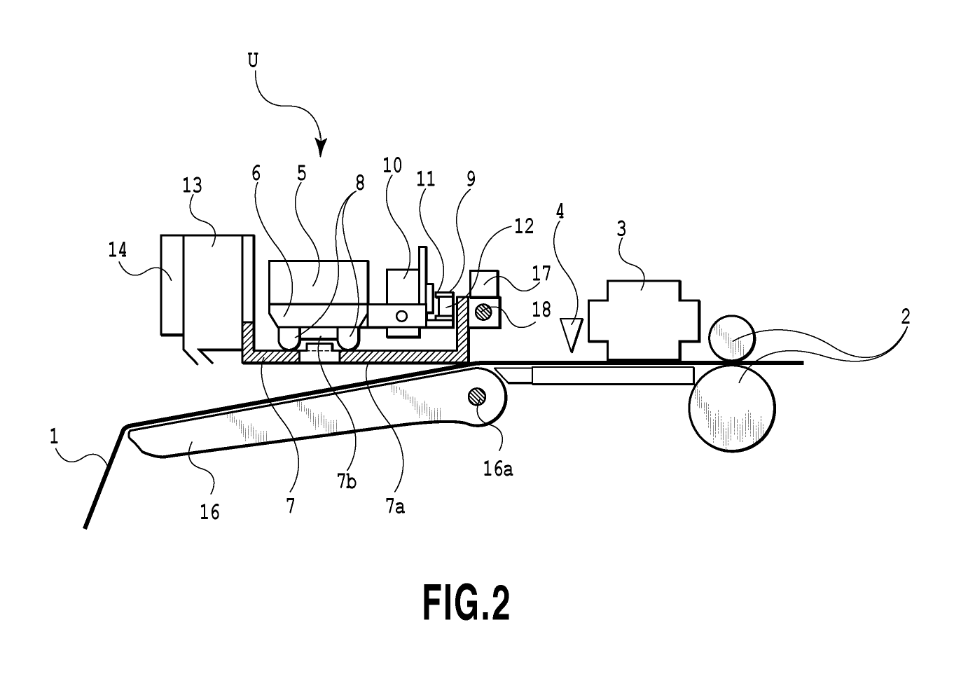

FIG. 2 is a cross section showing an example of an internal configuration of the recording apparatus according to the first embodiment in the present invention. A color measuring unit according to the present embodiment will be explained with reference to FIG. 2.

In the present recording apparatus, a color measuring sensor 5, a sensor retaining element 6, a support plate 7, sliding members 8, a belt 9, a motor 10, a motor pulley 11, an idler pulley 12, a drying duct 13 and a blower fan 14 are all integrally mounted. In the present specification, this integral configuration is called a color measuring unit U or a reading unit.

In the color measuring unit U, the color measuring sensor 5 for quantitatively measuring colors of the color patterns or reading other type of patters formed on the sheet, is retained by the sensor retaining element 6. The sensor retaining element 6 is connected to the support plate 7 in such a manner that the sliding members 8 provided on the bottom surface of the sensor retaining element 6 make contact with the support plate 7. In addition, the looped belt 9 engaged to the sensor retaining element 6 is bridged with tensions across between the motor pulley 11 and the idler pulley 12, and the sensor retaining element 6 is movable in the sheet width direction by the motor 10. At the moving of the sensor retaining element 6, posture accuracy between a pressing face 7a of the support plate 7 and the color measuring sensor 5 is maintained through the support plate 7, the sliding members 8 and the sensor retaining element 6.

A sheet discharge guide 16 is installed directly under the support plate 7. The sheet 1 is conveyed through an opening portion between the pressing face 7a and the sheet discharge guide 16. The color measuring sensor 5 scans in the sheet width direction on the support plate 7, and performs a color measuring operation to the sheet 1 through a slit 7b provided in the support plate 7.

The drying duct 13 and the blower fan 14 with a variable wind speed are provided downstream of the color measuring sensor 5 in the sheet conveying direction. The wind generated by the blower fan 14 is sent to the drying duct 13, and the wind blown out from the drying duct 13 is uniformly sprayed out to the surface of the sheet 1 on which the color pattern for color measuring is recorded, to speedup the drying of the color pattern for color measuring.

As explained above, the color measuring unit in the present embodiment has both a function of a color measuring device and a function of a drying device. However, the configuration of the color measuring unit which can be applied to the present embodiment is not limited thereto, and may allow the configuration where the color measuring device and the drying device are separately provided in the recording apparatus 100.

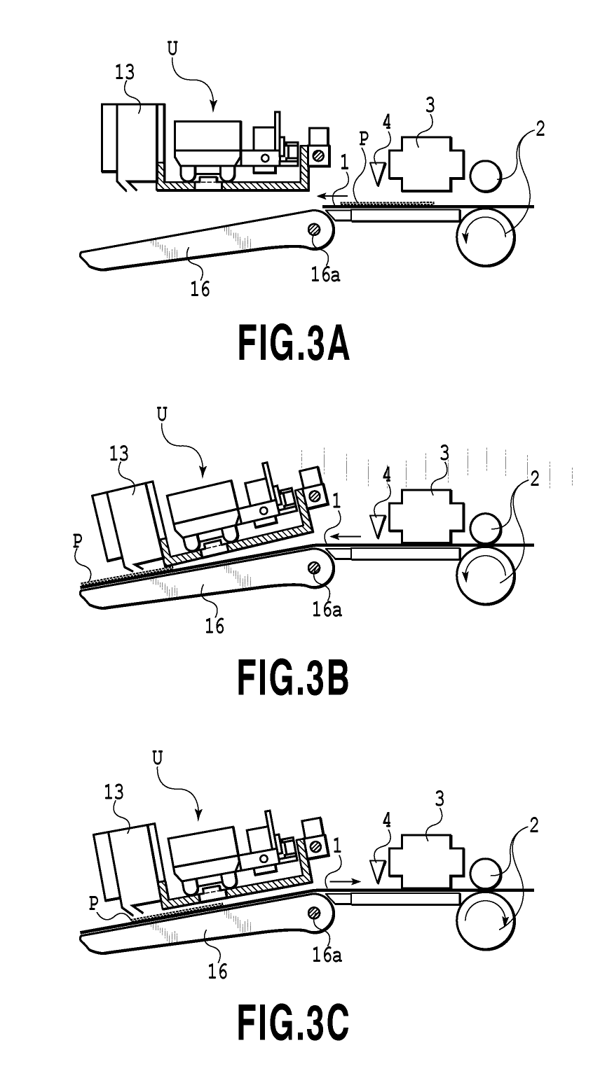

Next, an explanation will be made of a series of recording, drying, color measuring, and sheet discharging operations with reference to FIG. 3A to FIG. 3C.

The sheet 1 is intermittently conveyed in the sheet conveying direction (hereinafter, called a sheet discharge direction) toward the sheet discharge guide 16 in a state of being sandwiched and held by the pair conveying rollers 2, and in the meanwhile, the recording of a pattern row P constituting the color pattern for color measuring is performed by the inkjet head 3.

FIG. 3A shows a state of the internal configuration in the recording apparatus in a point where the recording of the pattern row P is completed. A front end of the sheet 1 is conveyed in the sheet discharge direction along the sheet discharge guide 16 by a length in the sheet conveying direction of the recorded pattern row P. The sheet 1 on which the recording is completed is next further conveyed in the sheet discharge direction, and is, as shown in FIG. 3B, stopped in a point where a rear end of the pattern row P, that is, an upstream end thereof in the sheet discharge direction enters into a drying region of the drying duct 13. Here, the blower fan of the drying duct 13 is made to be operated to dry the pattern row P for a predetermined time. Next, as shown in FIG. 3C, the sheet 1 is conveyed upstream in the sheet conveying direction in reverse to the previous direction, and is stopped in a point where an upstream end of the dried pattern row P in the sheet discharge direction comes directly under the color measuring sensor. Here, the color measuring sensor is operated to scan the sheet in the width direction to perform the color measuring of the pattern row P. In a case where the color pattern for color measuring comprises a plurality of pattern rows P, the color measuring is performed one row by one row, and a required intermittent conveyance is performed between the color measuring operations of the respective pattern rows P.

In a case where the plurality of pattern rows P are recorded over a length of the drying region of the drying duct 13 in the sheet conveying direction, the drying operation explained referring to FIG. 3B and the color measuring operation explained referring to FIG. 3C are repeated to the undried pattern row P.

After the color measuring operation is completed, the sheet 1 is cut by the cutter 4, and is discharged from the recording apparatus toward the inside of a basket (not shown) provided downward thereof under its own weight with rotation of the sheet discharge guide 16 around an axis 16a thereof.

### <Control System>

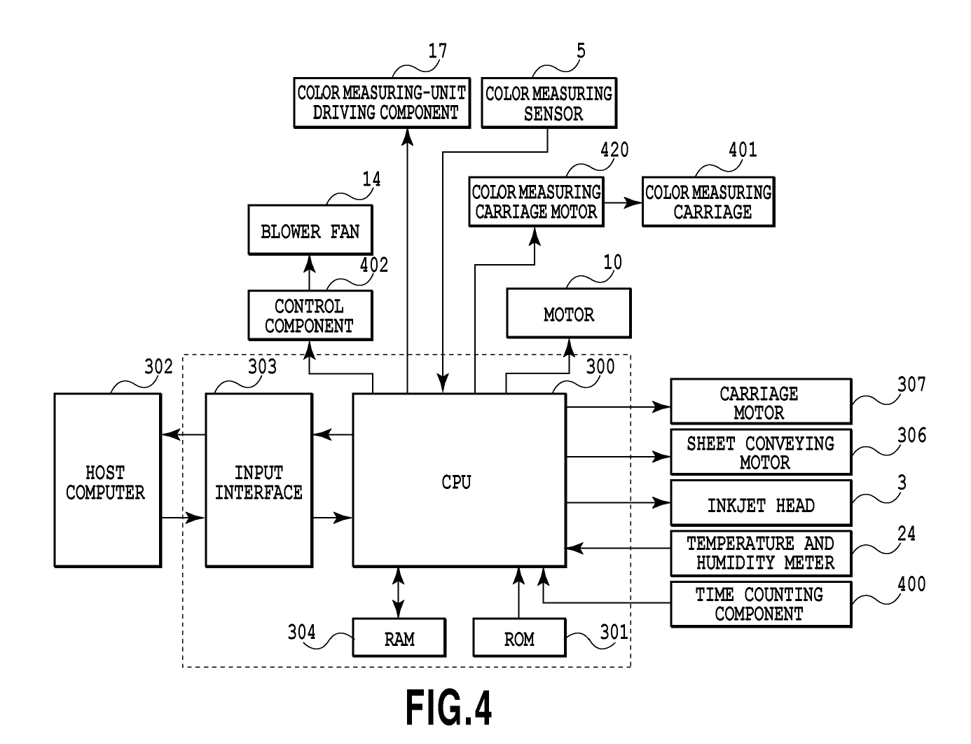

FIG. 4 is a block diagram showing a configuration example of a control system of the recording apparatus according to the present embodiment.

The recording apparatus according to the present embodiment includes a primary control component configured to include a CPU 300, a ROM 301, an input interface 303 and a RAM 304. The CPU 300 controls the entirety of recording, drying, color measuring, and conveying operations according to control programs stored in the ROM 301. In detail, the CPU 300 controls the inkjet head 3, a sheet conveying motor 306, a carriage motor 307, a motor 10, a control component 402 of the blower fan 14, a color measuring-unit driving component 17 and the like. The control of them is performed based upon record data and record mode setting information from a host computer 302, time information from a time counting component 400 for counting an elapse time after the recording is completed, temperature and humidity information from a temperature and humidity meter 24, and color measuring data from the color measuring sensor 5.

Input of the record data, the record mode setting information and the like to the CPU 300 from the host computer 302 is made through the input interface 303. In addition, the CPU 300 can write and read out the record data and the like in and from the RAM 304. The CPU 300 determines record control according to the record mode setting information, and starts the recording. The recording is performed in such a manner that the carriage motor 307 is driven to cause the carriage having mounted the inkjet head 3 thereon to scan the sheet in the width direction, and ink to be ejected on the sheet 1 from the inkjet head 3 according to the record data.

With this configuration, the recording of the color patterns for color measuring comprising the pattern rows for obtaining the color measuring data is performed to the sheet. As the recording is completed, the drying and the color measuring operations are performed.

The drying and the color measuring operations are controlled as follows. First, the sheet on which the color patterns for color measuring are recorded is conveyed to a drying region of the color measuring unit by driving the sheet conveying motor 306, wherein a drive of the blower fan 14 is started through the control component 402. Since the degree of the drying depends on a kind and size of the sheet, a density of a recorded image, a temperature, a humidity and the like, a predetermined time used for the drying is determined based upon a control table stored in the ROM 301 in advance.

After the drying for the predetermined time, the sheet is conveyed such that the pattern row dried in the drying region of the color measuring unit comes to the color measuring region of the color measuring unit. Next, the color measuring carriage motor 420 is driven to cause the color measuring carriage 401 having mounted the color measuring sensor thereon to scan the sheet in the width direction and to obtain color measuring data of the pattern row. The color measuring data of the single pattern row is obtained by a single scan. The scan and the intermittent conveyance of the sheet are repeated according to the number of the pattern rows to obtain the color measuring data of all the pattern rows dried by the aforementioned drying operation.

In a case where the pattern rows in the color patterns for color measuring are recorded over a length of the drying region of the color measuring unit in the sheet conveying direction, undried region of the pattern rows not dried by the aforementioned drying operation is present. In this case, the drying and the color measuring operations are likewise performed to the pattern rows in the undried region. These operations are repeated as needed to obtain color measuring data of all pattern rows in the color patterns for color measuring.

The color measuring data obtained as described above is transferred to the CPU 300, and is stored as color measuring information in the RAM 304. The color measuring information is sent to the host computer 302, which will be used as the subsequent color correcting information.

After completion of the color measuring operation, the drive of the blower fan 14 is stopped through the control component 402. The sheet is conveyed until a position of the sheet to be cut comes to a cutting position of the cutter 4, and the sheet cut by the cutter 4 is discharged inside the sheet discharge basket.

An explanation will be made of the first embodiment based upon the above configuration. In the present embodiment, the recovering operation of the inkjet head is performed at both of timing before the recording operation and timing after the color measuring operation of the color pattern for color measuring.

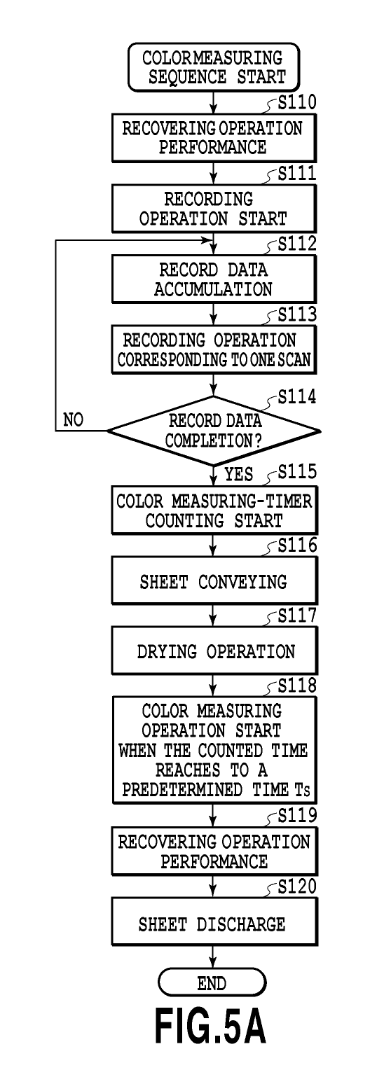

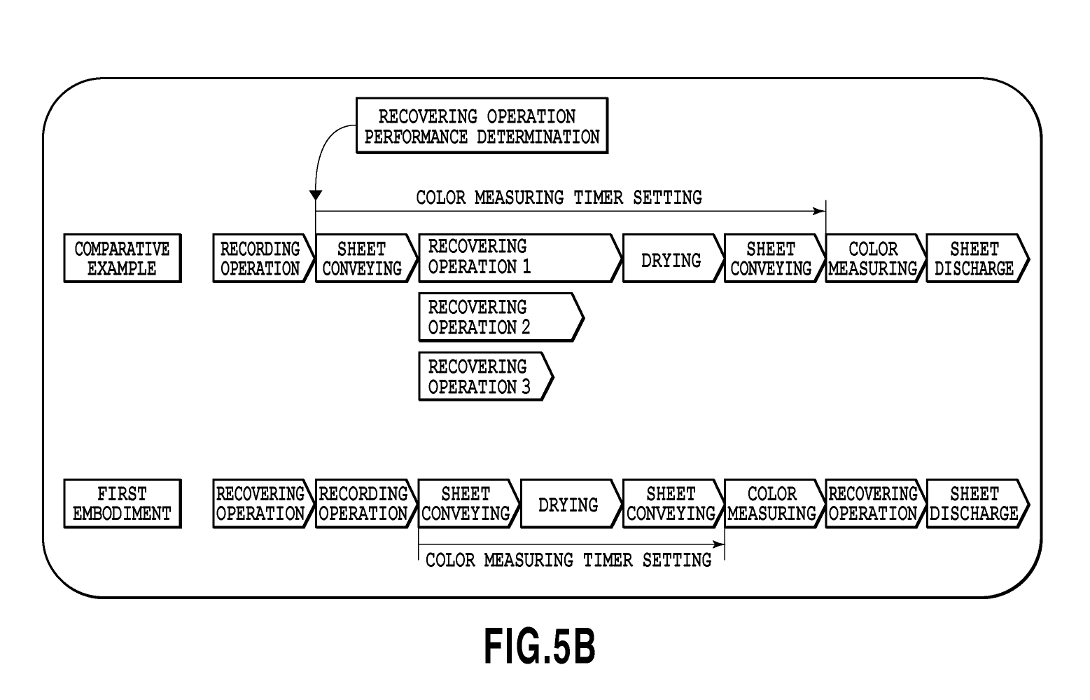

FIG. 5A shows a flow chart of a color measuring sequence in the first embodiment. In regard to the color measuring sequence, there are shown a series of operations including recording of the color pattern for color measuring, conveying, drying and color measuring of the sheet on which the color pattern for color measuring is recorded, and recovery of the inkjet head, which are performed for obtaining color measuring information used as color correcting information for color calibration.

As a command of performing the color measuring sequence is input by the operation panel 25 in the recording apparatus 100, at step S110 the recovering operation of the inkjet head 3 is first performed. Thereafter, at step S111a recording operation is started. At step 112 the inkjet head 3 waits until record data corresponding to a single scan of the inkjet head 3 is accumulated in a print buffer. When the record data is accumulated, at step 113 a recording operation corresponding to a single scan of the inkjet head 3 is performed to the sheet positioned in the recording region of the inkjet head 3, based upon the accumulated record data. Next, at step S114 it is determined whether or not the accumulation of the record data in regard to an entire image of the color pattern for color measuring to be recorded is completed. Ina case where the negative determination is made, the process returns to step S112, wherein the accumulation of the record data and the recording operation continue to be performed. The intermittent conveyance of the sheet 1 required for recording the image is performed between a plurality of recording operations. Step S112 to step S114 are repeated until the accumulation of the record data of the entire image of the color patterns for color measuring to be recorded is completed. In a case where at step S114 it is determined that the accumulation of the record data of the entire image of the color patterns for color measuring to be recorded is completed, the process goes to step S115, wherein the counting by a color measuring timer is started in a point where the recording operation is completed. Subsequently at step S116 the sheet 1 on which the color pattern for color measuring is recorded is conveyed to the drying region of the color measuring unit U. At step S117 the drying operation by the color measuring unit U is performed. After the drying operation is completed, at step S118 the dried sheet 1 is conveyed to the color measuring region of the color measuring unit U, and waits until an elapse time counted by the color measuring timer since the completion of the recording operation reaches to a predetermined time Ts. The predetermined time Ts is a constant time set as a time required for drying ink until a color of the ink becomes stable, according to various pieces of information. An example of the various pieces of information includes a kind of the color pattern for color measuring, a kind of the sheet, a kind, a record density and a record duty (corresponding to an ink amount to be applied) of ink, and the like. The predetermined time Ts is set based upon at least one of these pieces of the information. In a case of changing color patterns or sheets in use depending on the information, a predetermined time Ts suitable for each color pattern to be recorded or each sheet to be used is set.

When the counted time reaches to the predetermined time Ts, at step S118 the color measuring operation is started. In detail, the pattern rows constituting the color patterns for color measuring are measured in color one row by one row, and the color measuring operation continues to be performed until the pattern rows are all measured in color. The required intermittent conveyance of the sheet 1 is performed between the respective color measuring operations of the plurality of the pattern rows. After the color measuring operation is completed, at step S119 the recovering operation of the inkjet head 3 is performed. Finally at step S120 the sheet 1 is cut by the cutter 4, and a discharging operation of the sheet 1 is performed. It should be noted that the recovering operation of the step S119 and the discharging operation at step S120 may be performed at the same time. This process is likewise applied to a different embodiment to be described later. The color measuring sequence is completed in this way.

In this way, the first embodiment is characterized in that, in a regular recording operation, the recovering operation of the inkjet head 3 to be possibly performed after completion of the recording operation is performed at both of the timing before starting the recording operation and the timing after completing the color measuring operation of the color pattern for color measuring. As a result, the predetermined time Ts of the color measuring timer set as a constant time from the completion of the recording operation to the start of the color measuring operation can be set without considering the time required for performing the recovering operation of the inkjet head. Therefore the time from the completion of the recording operation to the start of the color measuring operation can be made constant, and can be made minimum necessary.

In the present embodiment, the recovering operation of the inkjet head 3 is performed at both of timing before the recording operation and timing after the color measuring operation of the color pattern for color measuring, but may be performed only in one of both the timings. In a case where the data of the color pattern for color measuring is not stored in the primary control component of the recording apparatus 100 and is unknown data input from outside, it is preferable that the recovering operation of the inkjet head 3 is performed at least before starting the recording operation.

An example of the recovering operation of the inkjet head 3 includes the suction operation in which, as described above, in a state where the cap 31 is jointed to the inkjet head 3 to form the sealed space therebetween, a vacuum is produced by the suction pump 33. In addition to it, there is a non-ejection detection inspection that ink is ejected to the sheet 1 from the inkjet head 3, and presence/absence of the ink ejection from each ink ejection opening in the inkjet head 3 is inspected by a sensor or the like. The recovering operation of the inkjet head applicable to the present embodiment is not limited to the suction operation, but also includes the non-ejection detection inspection and the other recovering operation of the inkjet head known in a person skilled in the art. In a case where the recovering operation of the inkjet head is performed at both of timing before the recording operation and timing after the color measuring operation of the color pattern for color measuring, it is preferable that the suction operation is performed before the recording operation, and the non-ejection detection operation is performed after the color measuring operation.

Here, FIG. 5B shows a timing chart of each of the first embodiment and a virtual comparative example, by which a particular effect by the present embodiment will be explained.

First, in the first embodiment, the recovering operation of the inkjet head is performed at both of timing before starting the recording operation and timing after completing the color measuring operation. In other words, the recovering operation of the inkjet head is prohibited within a period after the recording operation and before the color measuring operation. According to this embodiment, the necessary minimum time from completion of the recording operation to start of the color measuring operation is determined by a time required for drying the color pattern for color measuring and a time required for conveying the sheet. As described above, the time required for the drying is determined by at least one of the pieces of information of a kind of the color pattern for color measuring, a kind of the sheet, and a kind, a record density and a record duty (corresponding to an ink amount to be applied) of the ink. In addition, the time required for the conveying is determined by a conveying speed or the like of the recording apparatus. In a case of performing the color measuring sequence by plural times, the aforementioned necessary minimum time is difficult to change and is substantially constant. Therefore in the present embodiment, the predetermined time Ts of the color measuring timer set for making the time from completion of the recording operation to start of the color measuring operation constant may be determined simply considering the drying time and the conveying time.

On the other hand, in the comparative example, the recovering operation of the inkjet head is performed before starting the color measuring operation after completing the recording operation. According to the comparative example, the minimum time required from completion of the recording operation to start of the color measuring operation is determined based upon the time required for drying the color pattern for color measuring and the time required for conveying the sheet, and in addition to them, the time required for performing the recovering operation of the inkjet head. The content and the required time of the recovering operation of the inkjet head can change depending on the use condition of the inkjet head until this time (the ejection number of ink droplets from each ejection opening or the elapse time since the ink droplet is finally ejected from each ejection opening) or the like. Therefore the content and the required time of the recovering operation of the inkjet head are not necessarily constant. Accordingly, the predetermined time of the color measuring timer set for making the time from the completion of the recording operation to the start of the color measuring operation constant is required to be set in consideration of the drying time and the conveying time, and further, the longest recovering operation time estimated. As a result, according to the comparative example, either in a case where the recovering operation of the inkjet head is not necessary or in a case where the short time only is necessary for the recovering operation of the inkjet head, the time set as a constant time from the completion of the recording operation to the start of the color measuring operation becomes longer without no exception.

As described above, according to the first embodiment, which is different from the comparative example, the recovering operation of the inkjet head is performed before the start of the recording operation and/or after the completion of the color measuring operation. Therefore the predetermined time of the color measuring timer set as the constant time from the completion of the recording operation to the start of the color measuring operation can be set short without consideration of the time of the recovering operation which can change depending on the use condition of the inkjet head or the like.

### Second Embodiment

Hereinafter, a second embodiment will be explained omitting the explanation in common to the first embodiment.

The second embodiment uses a unit for determining whether or not a recovering operation of a recovering unit is required, and performs the recovering operation at a predetermined timing based upon the determination.

A determination on requirement/non-requirement of the recovering operation in the present embodiment is made based upon information of color patterns for color measuring as well as an elapse time since the previous recovering operation is performed, before starting the recording operation of the color pattern for color measuring. When the elapse time reaches to a predetermined timing, the recovering operation of the inkjet head is performed. In detail, a cumulative time Tm is found as a value made by adding a cumulative elapse time T counted by using a cumulative timer since the previous recovering operation is performed, to a recording operation time T₁ required for recording the color pattern for color measuring at this time. A point where the cumulative time Tm reaches to a threshold T_{L} or more of the cumulative timer is defined as the predetermined timing.

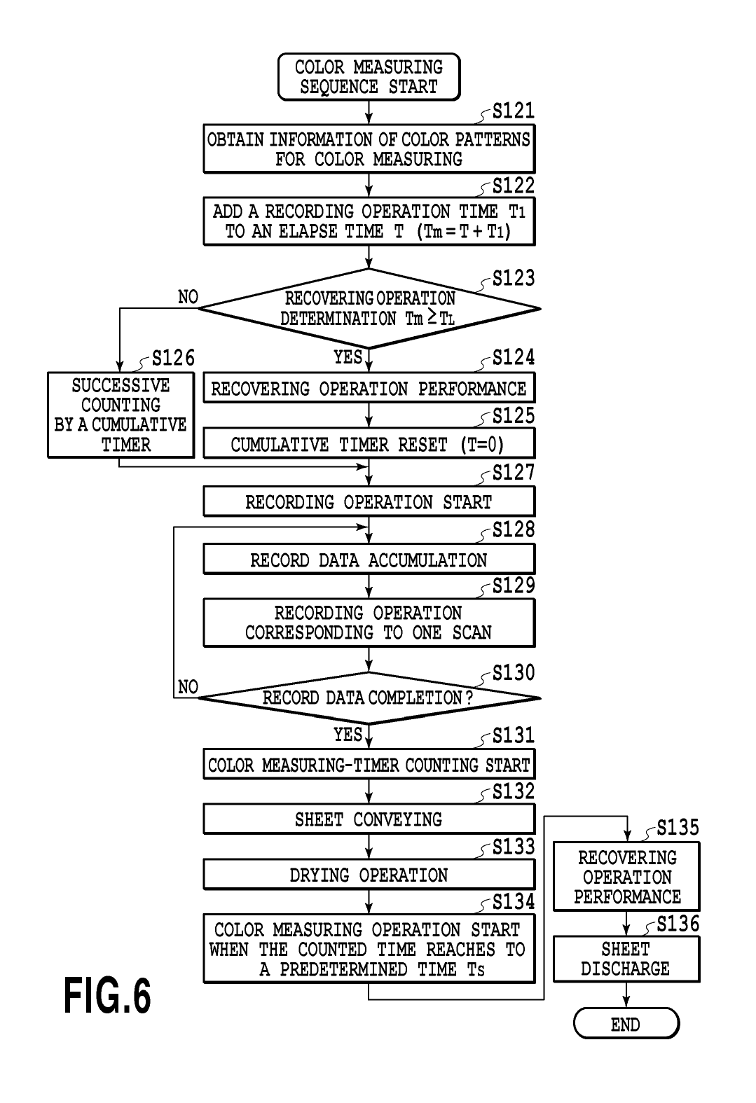

FIG. 6 shows a flow chart of a color measuring sequence according to the second embodiment.

As a command of performing the color measuring sequence is input by the operation panel 25 in the recording apparatus 100, at step S121 information of the color pattern for color measuring stored in the main body (for example, RAM 304) of the recording apparatus 100 is obtained. Here, the information of the color pattern for color measuring means a recording operation time T₁ required for once recording the color pattern for color measuring. At step S122 the recording operation time T₁ is added to a cumulative elapse time T shown by the cumulative timer to find a cumulative time Tₘ=T+T₁ estimated to elapse from a point where the previous recovering operation is performed to a point where the present recording operation is completed. At step S123 it is determined whether or not the obtained cumulative time Tₘ is equal to or more than the threshold T_{L} of the cumulative timer.

In a case where the obtained cumulative time Tₘ is equal to or more than the threshold T_{L} of the cumulative timer, at step S124 the recovering operation of the inkjet head is performed. Next, at step S125 the cumulative timer is reset to once set a value of the cumulative elapse time T shown by the cumulative timer to a zero, and then the counting of the time is newly started. Next, at step S127 a recording operation is started.

In a case where the obtained cumulative time Tᵣ, is less than the threshold T_{L} of the cumulative timer, the recovering operation of the inkjet head is not performed before recording the color pattern for color measuring. At step S126 in a state where, without resetting the cumulative timer, the value of the cumulative elapse time T shown by the cumulative timer is kept as an actually counted value, the accumulation of the subsequent elapse time continues to be performed. Next, at step S127 the recording operation is started.

Operations subsequent to the recording operation shown at step S127 to step S136 are the same as those subsequent to the recording operation in the first embodiment (refer to step S111 to step S120 in FIG. 5A).

In this way, the second embodiment is characterized in that the cumulative elapse time since the previous recovering operation is completed is found before performing the recording operation of the color pattern for color measuring, the determination on the requirement/non-requirement of the recovering operation is made based upon the cumulative elapse time, and the recovering operation is performed according to this determination.

According to the second embodiment, the recovering operation to be possibly performed before starting the color measuring operation after the completion of the recording operation can be performed before starting the recording operation. Since the recovering operation having been possibly performed after the completion of the recording operation of the color pattern for color measuring is in advance performed, the predetermined time Tₛ of the color measuring timer set as the constant time from the completion of the recording operation to the start of the color measuring operation can be set without consideration of the recovering time. Therefore while keeping the time from the completion of the recording operation to the start of the color measuring operation to be constant, the time can be made minimum necessary.

According to the second embodiment, the determination on the requirement/non-requirement of the recovering operation is made based upon the information of the color pattern for color measuring, and the recovering operation is performed based upon the determination. Therefore a deviation between the timing when the recovering operation is originally required and the timing when the recovering operation is actually performed is made small, and an increase in the waste ink amount caused by the recovering operation is suppressed to the minimum.

The second embodiment is explained with reference to an example for recording the color patterns for color measuring by using the data stored in the main body of the recording apparatus 100. In a case of using the data stored in the main body, since the information of the color pattern for color measuring is in advance stored, it is possible to make a determination on the recovering operation based upon the information.

In the present invention, it is possible to use the data of the color patterns for color measuring produced by a user. In a case of first using the data produced by a user, since the information of the color patterns for color measuring is not in advance stored in the main body of the recording apparatus 100 and is unclear, a determination on the recovering operation cannot be made. Therefore the flow chart in the first embodiment shown in FIG. 5A is executed. In a case of using the data produced by a user at the second time or further after that, since the information of the color patterns for color measuring is already stored in the main body of the recording apparatus 100, the flow chart in the second embodiment shown in FIG. 6 can be applied.

### Third Embodiment

Hereinafter, a third embodiment will be explained omitting the explanation in common to the first embodiment and the second embodiment.

The third embodiment, as similar to the second embodiment, uses a unit for determining whether or not a recovering operation of a recovering unit is required, and performs the recovering operation based upon the determination at a predetermined timing.

A determination on requirement/non-requirement of the recovering operation in the third embodiment is made based upon information of a color pattern for color measuring as well as the ejection number of ink from the inkjet head since the previous recovering operation is performed, before starting the recording operation of the color pattern for color measuring. At timing when the ejection number of the ink reaches to a predetermined number, the recovering operation of the inkjet head is performed. In detail, a cumulative ejection number Dₜ is found as a value made by adding a cumulative ejection number D counted by using an ejection counter since the previous recovering operation is performed, to a recording ejection number D₁ required for recording the color pattern for color measuring at this time. A point where the cumulative ejection number Dₜ reaches to a threshold D_{L} or more of the ejection counter is defined as the predetermined timing.

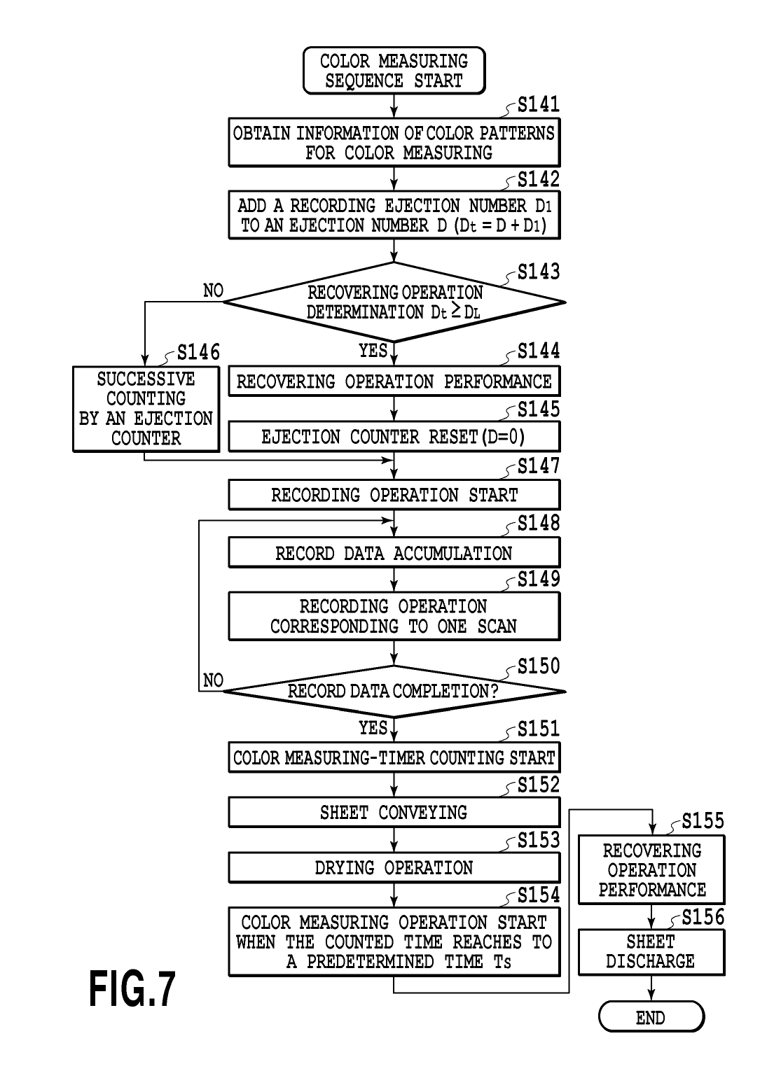

FIG. 7 shows a flow chart of a color measuring sequence according to the third embodiment.

As a command of performing the color measuring sequence is input by the operation panel 25 in the recording apparatus 100, at step S141 information of color patterns for color measuring stored in the main body (for example, RAM 304) of the recording apparatus 100 is obtained. Here, the information of the color pattern for color measuring means a recording ejection number D₁ required for once recording the color pattern for color measuring. At step S142 the recording ejection number D₁ is added to a cumulative ejection number D shown by the ejection counter to find a cumulative ejection number Dₜ=D+D₁ estimated to eject from a point where the previous recovering operation is performed to a point where the present recording operation is completed. Next, at step S143 it is determined whether or not the obtained ejection number Dₜ is equal to or more than the threshold D_{L} of the ejection counter.

In a case where the cumulative ejection number Dₜ is equal to or more than the threshold D_{L} of the ejection counter, at step S144 the recovering operation of the inkjet head is performed. Next, at step S145 the ejection counter is reset to once set a value of the cumulative ejection number D shown by the ejection counter to a zero, and then the counting of the ejection number is newly started. Next, at step S147 the recording operation is started.

In a case where the cumulative ejection number Dₜ is less than the threshold D_{L} of the ejection counter, the recovering operation of the inkjet head is not performed before recording the color pattern for color measuring. At step S146 in a state where, without resetting the ejection counter, the value of the cumulative ejection number D shown by the ejection counter is kept as an actually measured value, the accumulation of the subsequent ejection number continues to be performed. Next, at step S147 the recording operation is started.

Operations subsequent to the recording operation shown at step S147 to step S156 are the same as those subsequent to the recording operation in the first embodiment (refer to step S111 to step S120 in FIG. 5A).

In this way, the third embodiment is characterized in that the cumulative ink ejection number since the previous recovering operation is completed is found before performing the recording operation of the color pattern for color measuring, a determination on the requirement/non-requirement of the recovering operation is made based upon the cumulative ink ejection number, and the recovering operation is performed according to this determination.

According to the third embodiment, the recovering operation to be possibly performed before starting the color measuring operation after completion of the recording operation can be performed before starting the recording operation. Since the recovering operation having been possibly performed after the completion of the recording operation of the color pattern for color measuring is in advance performed, the predetermined time Tₛ of the color measuring timer set as the constant time from the completion of the recording operation to the start of the color measuring operation can be set without consideration of the recovering operation. Therefore while keeping the time from the completion of the recording operation to the start of the color measuring operation to be constant, the time can be made minimum necessary.

According to the third embodiment, the determination on the requirement/non-requirement of the recovering operation is made based upon the information of the color pattern for color measuring, and the recovering operation is performed based upon the determination. Therefore a deviation between the timing when the recovering operation is originally required and the timing when the recovering operation is actually performed is made small, and an increase in the waste ink amount caused by the recovering operation is suppressed to the minimum.

The third embodiment is explained with reference to an example for recording the color patterns for color measuring by using the data stored in the main body of the recording apparatus 100. In a case of using the data stored in the main body, since the information of the color patterns for color measuring is in advance stored, it is possible to make a determination on the recovering operation based upon the information.

In the present invention, it is possible to use the data of the color patterns for color measuring produced by a user. In a case of first using the data produced by a user, since the information of the color pattern for color measuring is not in advance stored in the main body of the recording apparatus 100 and is unclear, a determination on the recovering operation cannot be made. Therefore the flowchart in the first embodiment shown in FIG. 5A is executed. In a case of using the data produced by a user at the second time or further after that, since the information of the color pattern for color measuring is already stored in the main body of the recording apparatus 100, the flow chart in the third embodiment shown in FIG. 7 can be applied.

The predetermined timing in the determination of the recovering operation is defined using the ink ejection number from the inkjet head 3 since a point where the previous recovering operation is completed in the third embodiment, and in the second embodiment, is defined using an elapse time since a point where the previous recovering operation is completed. In the present invention, the predetermined timing may be defined using both of the ink ejection number and the elapse time.

### Fourth Embodiment

Hereinafter, a fourth embodiment will be explained omitting the explanation in common to the first embodiment.

The fourth embodiment shows an example to which the color measuring sequence according to the first embodiment is applied in a case where color patterns for color measuring are recorded by a plurality of times of recording operations.

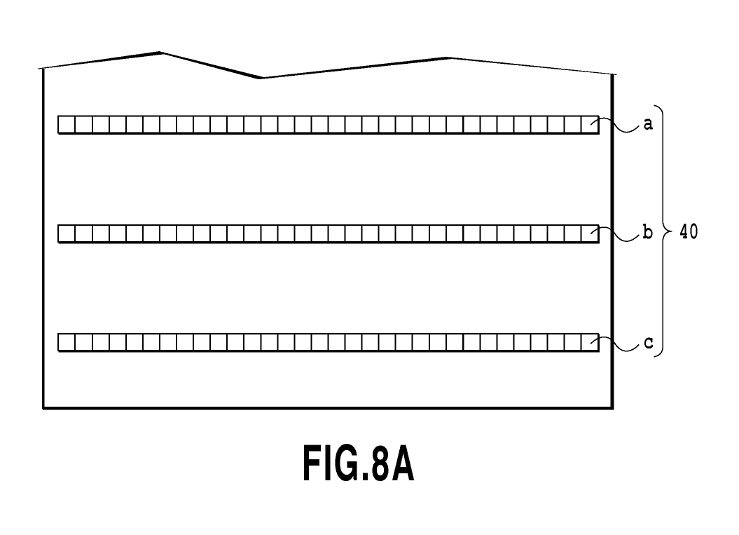

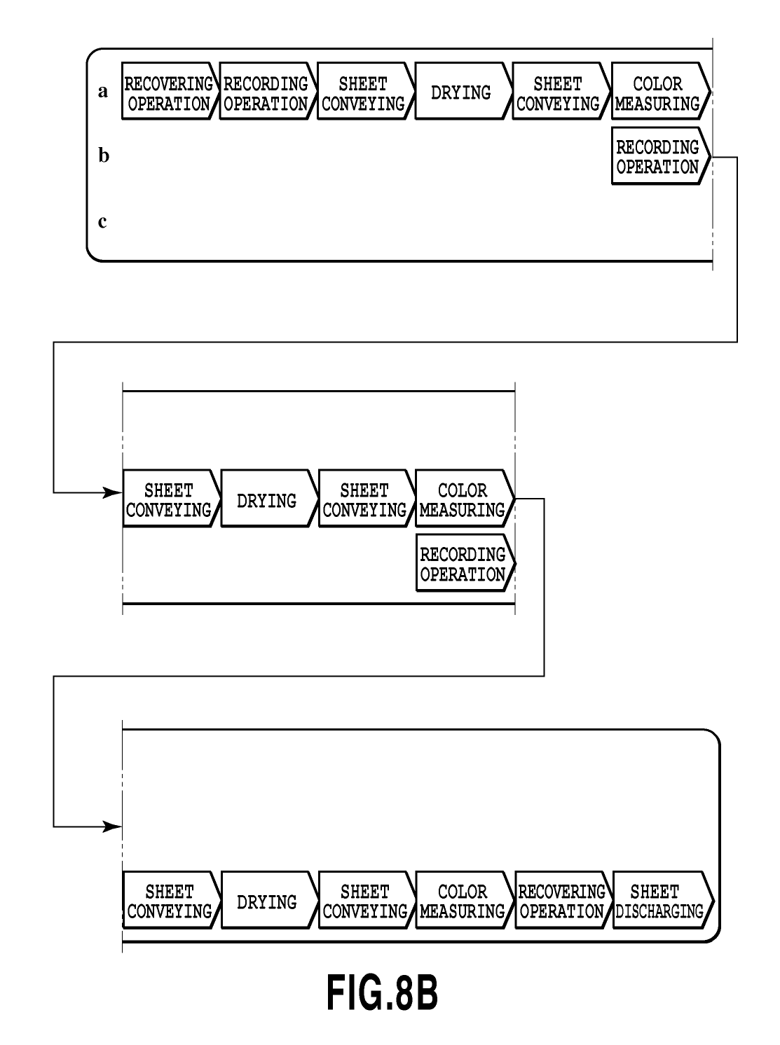

FIG. 8A shows color patterns for color measuring configured of a plurality of pattern rows according to the fourth embodiment. The color patterns for color measuring 40 are configured of pattern rows 40a, 40b and 40c, and each pattern row shows a pattern in which color patches of inks in respective colors are arrayed in a lattice shape.

FIG. 8B shows a timing chart of a color measuring sequence in regard to the color patterns for color measuring recorded by a plurality of recoding operations.

In the color measuring sequence according to the fourth embodiment, first, a recovering operation of the inkjet head 3 is performed as similar to the first embodiment (refer to step S110 in FIG. 5A). After that, operations from a recording operation to a color measuring operation in regard to the pattern row 40a as the first row are performed (refer to step S111 to step S118 in FIG. 5A). At this time, a recording operation in regard to the pattern row 40b as the second row is started (refer to step S111 in FIG. 5A) at the same time when the color measuring operation in regard to the pattern row 40a as the first row is started (refer to step S118 in FIG. 5A). Further, operations from accumulation of the record data to a color measuring operation in regard to the pattern row 40b as the second row are performed (refer to step S112 to step S118). Likewise, a recording operation in regard to the pattern row 40c as the third row is started (refer to step S111 in FIG. 5A) at the same time when the color measuring operation in regard to the pattern row 40b as the second row is started (refer to step S118 in FIG. 5A). Subsequently, operations from accumulation of the record data to a color measuring operation in regard to the pattern row 40c as the third row are performed (refer to step S112 to step S118 in FIG. 5A). Finally a recovering operation of the inkjet head (refer to step S119 in FIG. 5A) and a discharging operation of the sheet (refer to step S120 in FIG. 5A) are performed to complete the color measuring sequence.

In this way, according to the fourth embodiment, at the time of performing the color measuring sequence in a case where the color patterns for color measuring are recorded by the plurality of times of the recording operations, the color measuring operation in the previously recorded region is started, and at the same time, the recording operation in the region to be next recorded is started. Therefore, according to the fourth embodiment, the time from the completion of the recording operation to the start of the color measuring operation can be made minimum necessary as similar to the first embodiment to the third embodiment, and the time of the entire color measuring sequence can be made short.

In addition, the present color measuring sequence can be also applied to a recording apparatus having a different configuration from that of the present embodiment. That is, in a case of the configuration where the recording operation, the drying operation and the color measuring operation are sequentially performed in that order in regard to each of the plurality of the patterns, the effect of shortening the time of the entire color measuring sequence can be likewise obtained by performing the respective operations to overlap in the plurality of the patterns. For obtaining the time shortening effect to be further improved in the entire color measuring sequence, the recovering operation of the inkjet head may be, as described above, performed during the discharging operation of the sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-052893, filed Mar. 9, 2012, which is hereby incorporated by reference herein in its entirety.

What is claimed is:

1. A color measuring method, comprising:
recording color patterns on a sheet by an inkjet head;
measuring colors of the color patterns formed on the sheet; and
recovering the inkjet head,
wherein the recovering is prohibited within a period after the recording and before the measuring.

2. A color measuring method according to claim 1, further comprising performing a color calibration for printing by the print head based on the measurement.

3. A color measuring method according to claim 1, further comprising drying the sheet on which the color patterns are recorded, wherein the dried sheet is measured.

4. A color measuring method according to claim 1, further comprising discharging the sheet after the measuring, wherein the recovering is performed during the discharging.

5. A color measuring method according to claim 1, wherein a time to start the measuring is set by at least one of pieces of information of a kind of the color pattern, a kind of the sheet, a kind of ink, a record density, and a record duty.

6. A color measuring method according to claim 1, further comprising determining whether or not the recovering is required based upon predetermined information before starting the recording step.

7. A color measuring method according to claim 6, wherein the information includes at least one of an elapse time since the previous recovering, and an ink amount ejected from the inkjet head since the previous recovering.

8. A color measuring method according to claim 7, wherein, in a case where the information is unclear, the recovering is performed before the recording.

9. A recording apparatus comprising:
a recording unit having an inkjet head configured to record patterns on a sheet;
a reading unit configured to read the patterns formed by the recording unit; and
a recovering unit configured to recover the inkjet head,
wherein the recovering by the recovering unit is prohibited within a period after the recording by the recording unit and before the reading by the reading unit.

10. A recording apparatus according to claim 9, further comprising a drying unit configured to dry the sheet on which the patterns are recorded by the recording unit.
